(19) United States
(12) Patent Application Publication
(10) Pub. No.: US 2010/0141469 A1
(43) Pub. Date: Jun. 10, 2010

(54) APPARATUS AND METHOD FOR OPERATING HOME NETWORK BY USING BUILDING STRUCTURE DRAWING

(76) Inventors: Young Sung SON, Daejeon (KR); Kyeong Deok MOON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/465,697

(22) Filed: May 14, 2009

(30) Foreign Application Priority Data
Dec. 9, 2008 (KR) 10-2008-0124372

(51) Int. Cl. G05B 19/04

(52) U.S. Cl. 340/825.22

(57) ABSTRACT

An apparatus for operating a home network includes a plurality of devices connected through the home network; and a building structure drawing DB for storing a building structure drawing regarding the inside of the building. Further, the apparatus for operating a home network includes a home network management system for generating service execution scheme information to provide an application service by using each device based on home network state information, determining building structure and home network configuration information based on building structure drawing information and the generated service execution scheme information, and controlling each device by determining whether to operate the application service.

### CROSS-REFERENCE TO RELATED APPLICATIONS

The present invention claims priority of Korean Patent Application No. 10-2008-0124372, filed on Dec. 9, 2008, which is incorporated herein by reference.

### FIELD OF THE INVENTION

The present invention relates to a technique for executing a service operatively connected to a device in a network environment connecting a number of devices, and more particularly, to an apparatus and method for operating a home network by using a building structure drawing which is suitable to perform the operation of an application service in the home network environment by using information of building structure drawing to change the operation of the application service.

### BACKGROUND OF THE INVENTION

In a general home network system, when a home network connects multiple devices installed in a home or an office, a home network management system for integrally managing the devices confirms the state of each device through the network and controls each device by sending and receiving a control command therefor.

The home network system is operatively connected to a wire/wireless terminal. To input a control command, a user has access to the home network system by using the wire/wireless terminal. The home network system receives the control command being input by the user and performs remote control of the relevant device, based on the control command.

As described above, features of each device, features of a network connecting the devices and features of a home network management system are preset and managed, thereby effectively operating the home network system.

In the aforementioned home network system, the features of each device, a network connecting devices and a home network management system are preset and managed for effective operation of the home network system. However, since the conventional home network system is simply operated, based on only the preset information of the device and network, according to the control command of the user, it is likely to be inefficiently operated upon lighting control, air conditioner control and temperature control.

### SUMMARY OF THE INVENTION

In view of the above, the present invention provides an apparatus and method for operating a home network by using a building structure drawing, whereby, in a home network environment operatively connecting a number of devices and services, building structure drawing information is used when application service logic is executed to be automatically revised.

Further, the present invention provides an apparatus and method for operating a home network by using a building structure drawing, whereby suitable control is performed by perceiving device state information, each device being operatively installed in a home network, home network state information, system state information, service state information and building structure drawing information, and by determining application service logic, based on the perceived state information.

Further, the present invention provides an apparatus and method for operating a home network by using a building structure drawing, whereby, whenever types of a home network, device, system and service are added in the home network environment operatively connecting a number of devices and services, the relations to the building structure drawing are perceived and a selected resource is changed or a new efficient resource is added so that a resource selecting policy is selectively expanded.

In accordance with a first aspect of the present invention, there is provided an apparatus for operating a home network, including: a plurality of devices connected through the home network; a building structure drawing DB for storing a building structure drawing regarding the inside of the building; and a home network management system for generating service execution scheme information to provide an application service by using each device based on home network state information, determining building structure and home network configuration information based on building structure drawing information and the generated service execution scheme information, and controlling each device by determining whether to operate the application service.

In accordance with a second aspect of the present invention, there is provided a method for operating a home network, including: generating service execution scheme information based on home network state information and device state information when an application service of the home network is performed, wherein a plurality of devices are connected to the home network; and controlling each device by determining a building structure and home network configuration information based on building structure drawing information in addition to the generated service execution scheme information, and revising service execution scheme information to operate the application service.

In accordance with the present invention, a suitable control is performed by perceiving the device state information, each device being operatively installed in a home network, the home network state information, the system state information, the service state information and the building structure drawing information, and by determining the application service logic based on the perceived state information.

Further, whenever types of a home network, device, system and service are added, relations to the building structure drawing are expanded by changing a selected resource or adding a new efficient resource to be selected through the resource selection policy. Therefore, there are the effects in that the apparatus and method for operating a home network by using a building structure drawing are applicable to the field of home network maintenance and repair and perform effective operation in accordance with the building structure upon lighting control, air-conditioner control, temperature control and/or the like.

### BRIEF DESCRIPTION OF THE DRAWINGS

The objects and features of the present invention will become apparent from the following description of embodiments given in conjunction with the accompanying drawings, in which:

FIG. 1 is a block diagram illustrating a configuration of an apparatus for operating a home network in accordance with an embodiment of the present invention;

FIGS. 2A and 2B are flow charts illustrating a procedure in which an application service executed in the home network actually controls a device;

FIG. 3 is a block diagram illustrating the operation of an application service in the home network by using a building structure drawing; and

FIG. 4 is a flow chart illustrating a process in which an application service in the home network is executed by using the building structure drawing.

### DETAILED DESCRIPTION OF THE EMBODIMENTS

Hereinafter, exemplary embodiment of the present invention will be described in detail with reference to the accompanying drawings which form a part hereof.

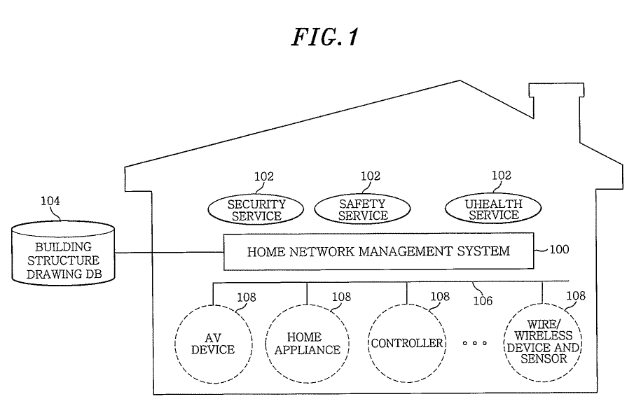

FIG. 1 illustrates the configuration of an apparatus for operating a home network in accordance with an embodiment of the present invention.

Referring to FIG. 1, the apparatus for operating a home network includes a home network management system 100, an application service 102, a building structure drawing DB 104, a home network 106 and a home network device 108. When the application service 102 is executed, the apparatus for operating a home network provides a system environment for more efficient operation, based on information of the building structure drawing provided from the building structure drawing DB 104.

The building structure drawing DB stores a building structure drawing regarding the inside of the building.

Many different home network devices 108 are installed in a home. Examples of the home network devices 108 include the A/V devices such as a video camera, a television, a set-top box and the like; the home appliances such as an electronic range, an air conditioner, a fan and the like; the controllers such as a gas valve, a water supply valve, windows and curtains, security systems and the like; and various wire/wireless devices and sensors. The home network devices 108 are connected through the home network 106 to the home network management system 100.

The application services 102 include security service, safety service, health service and the like.

The home network management system 100 manages all of the home network devices 108 connected within the home. When any one of the application services 102 is selected by a user or when a preset application service is performed, the home network management system 100 controls the home network device 108 related to the application service 102. For example, at least any one of lighting control, air conditioner control and temperature control is performed.

That is, since the home network management system 100 perceives the features of each home network device 108, it performs the operation needed for each application service 102. Then, the application service 102 can be further performed, based on the information of the building structure drawing provided from the building structure drawing DB 104. In this case, the home network management system 100 determines home network configuration information, based on the building structure drawing, and determines which application service 102 is selected so that each home network device 108 can be performed.

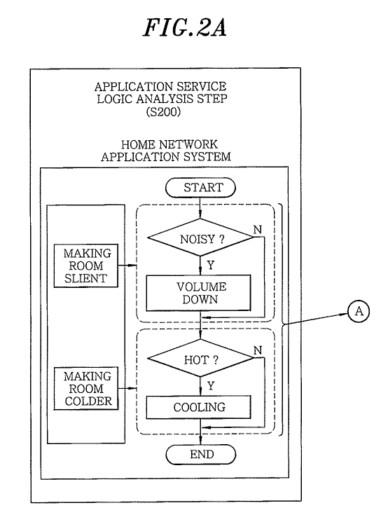

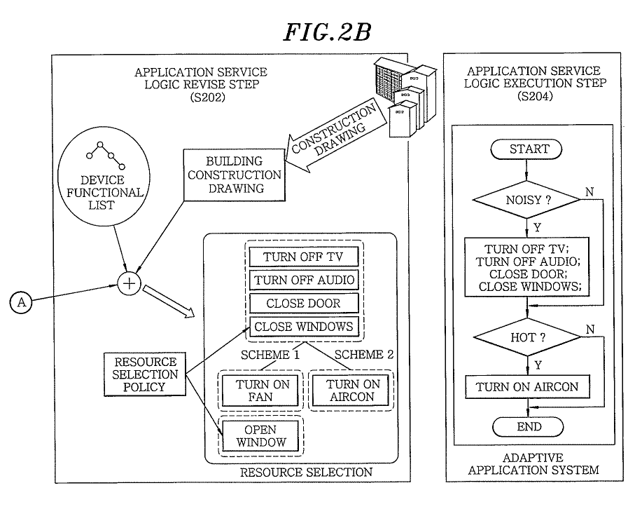

FIGS. 2A and 2B illustrate procedures in which an application service is executed in the home network 106 to actually control a device related to the application service.

With reference to FIGS. 2A and 2B, the home network management system 100 supports more efficient operation of the application service depending on information about devices, home network and service state, based on the revised application service using the building structure drawing. In a step of analyzing an application service logic as shown in FIG. 2A, service execution scheme information of the application service requested by a user is generated to include device control information to be executed by perceiving the home network state information.

For example, when a user wants to make a room quiet and selects the function, “Making Room Quiet”, on an operation panel connected to the home network management system 100, or when noise information sensed by a noise sensing senor is transmitted to the home network management system 100, whether it is a noise or not is determined on the basis of the noise information. When the sensed noise is higher than a predetermined noise level, “Volume Down”, “Close Windows or close Curtain” and/or the like are set as the service execution scheme information to control the noise.

That is, when an audio system outputs a sound, audio volume control is set as the service execution scheme information to turn down the volume of the audio system. Then, when the audio system is turned off but any windows are open, the service execution scheme information of “Close Windows” is set.

Further, when the user selects the function, “Making Room Cool”, or when a temperature sensed by a temperature sensor is received in the home network management system 100 and it is higher than a preset temperature, the service execution scheme information is set for cooling control. To be more specific, the scheme to perform the cooling control includes “Open Windows” or “Turn on Fan/Air-con” to cool the Room 1 where a device for the cooling control is provided.

In a step of revising an application service logic S202 as shown in FIG. 2B, revised service execution scheme information capable of being actually executed is generated by matching the service execution scheme information being set in the home network management system 100 with the functional list of the devices within the home, the device and network state information, and the building structure drawing. The functional list of the devices includes device list and functions of the devices. For example, the air-con has functions of cooling, reservation, power-saving and the like the fan has functions of fan, timer and the like. The building structure drawing has a building structure and information about installing position of the devices. For example, an inner room and a living room are connected each other and the air-con is provided in the living room. When the air-con is provide for function of cooling, revised service execution scheme information is generated to operate the air-con. Here, when a plurality of devices exist for the same functions, the device is selected according to the resource selection policy to generate the revised service execution scheme information.

Specifically, when the device and network are normally operated for example, a resource selection policy is confirmed by referring to the building structure drawing.

The resource selection policy of the function, “Making Room Quiet”, includes “Turn off TV”, “Turn off Audio”, “Close Door”, “Close Windows” and the like. Among these resources, one or more resources may be selected and operated.

The resource selection policy of the function, “Making Room Cool”, includes “Turn on Fan”, “Open Windows”, “Turn on Air-con” and the like. Among these resources, one or more resources are selected and operated.

The aforementioned resource selection policy is merely provided as an example. Not only the functions of “Turn on” and “Turn off” but also the functions of volume control, fan speed control and air-con temperature control are available.

In a step of executing an application service logic S204 in FIG. 2B, the home network is controlled by actually operating a device, a network and a system service according to the service execution scheme information revised by referring to the building structure drawing in the application service logic revise step S202.

For example, the home network control is performed, based on the resource selected in the application service logic revise step S202. When noise in room is higher than the predetermined noise level or when the user selects the function, “Making Room Quiet”, a TV is turned off, an audio system is turned off, and a door and windows are shut.

Further, when the temperature of Room is higher than the predetermined temperature or when the user selects the function, “Making Room Cool”, an air-con is turned on to perform the home network control.

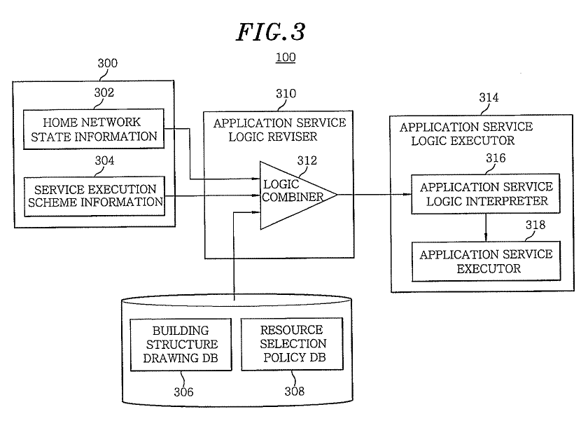

FIG. 3 illustrates a block diagram of the home network management system shown in FIG. 1.

With reference to FIG. 3, a home network management system 100 includes an application service logic analyzer 300, an application service logic reviser 310, and an application service logic executor 314. The home network management system 100 executes logic combination and adaptive application service logic, based on a building structure drawing DB 306 and a resource selection policy DB 308 connected therewith. The resource information of the resource selection policy DB 308 includes the functional service execution scheme information of each device and includes the information, such as device control mode and form, control by time, power on/off and the like.

Specifically, the application service logic analyzer 300 analyzes network topology information and device state information by monitoring the home network state in real-time, to generate home network state information 302 and to generate service execution scheme information 304 setting a service execution scheme of an application service to be automatically performed through the apparatus for operating a home network. The service execution scheme information 304 is resulted by generating a functional control scheme of each device to perform the application service.

The home network state information 302 and the service execution scheme information 304 are transferred to the application service logic reviser 310.

The application service logic reviser 310 combines logic by using a logic combiner 312, based on the home network state information 302 and the service execution scheme information 304 transferred from the application service analyzer 300, and the building structure drawing DB 306 and the resource selection policy DB 308 connected to the home network management system 100, to determine whether to revise the service execution scheme information being generated in the application service logic analyzer 300. When any revise is needed, the application service logic reviser 310 performs the revise accordingly.

That is, the application service logic reviser 310 additionally selects or excludes the service execution scheme information by determining whether to re-select a resource, based on the information of the resource selection policy DB 308 when the logic is combined using the logic combiner 312. When the existing service scheme is maintained or new service execution scheme information is generated through the application service logic reviser 310, the existing service scheme or the new service execution scheme information is transferred to the application service logic executor 314. An application service logic interpreter 316 interprets the service execution scheme information transferred from the application service logic reviser 310, to confirm relevant device control information and to transfer the device control information to the application service executor 318.

The application service executor 318 transmits a control command to each of the relevant devices, based on the transferred device control information.

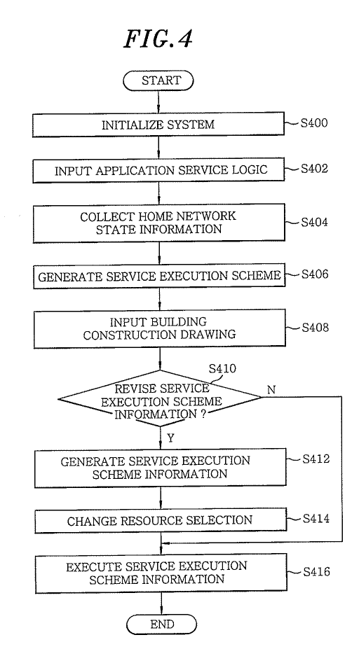

FIG. 4 is a flow chart illustrating a process in which a home network application service is executed by using a building structure drawing according to the embodiment of the present invention.

Referring to FIG. 4, system initialization is performed in step S400. When a user selects and inputs any specific application service into a home network management system 100, when value of temperature, noise or the like is higher than that of a predetermined one, or when any application service is reserved by the user, in step 402, the relevant application service is automatically performed in the home network management system 100.

That is, when the application service from the user is inputted to an application service logic analyzer 300 in the home network management system 100 receives, home network state information 302, i.e., state information of the home network and devices connected therewith, is collected in step S404 and service execution scheme information 304 corresponding to the application service is generated based on the home network and device state information in step S406.

The home network state information 302 and the service execution scheme information 304 are transferred to the application service logic reviser 310. When the application service logic reviser 310 receives the input of a relevant building structure drawing from a building structure drawing DB 306 in step S408, the logic combiner 312 determines whether to revise the service execution scheme information compared to the building structure, by including the building structure drawing in the home network state information 302 and the service execution scheme information 304 in step S410.

When the service execution scheme information does not need to be revised, the predetermined service execution scheme information is executed in step S416. However, when the service execution scheme information based on the building structure is needed to be revised in step S410, the service execution scheme information is re-generated by referring to the building structure drawing in step S412, and the resource selection is changed by selecting a resource corresponding to the service execution scheme information through the resource selection policy DB 308 in step S414. Subsequently, logic is performed based on the revised service execution scheme information in step S416.

As described above, in the apparatus and method for operating a home network by using a building structure drawing according to the present invention, suitable control is performed in the home network environment in which a number of devices and services are operatively connected, by perceiving the state information of the devices operatively installed in a home network, the home network, the system, the service and the building structure drawing information, and by determining the application service logic based on the perceived state information.

Furthermore, in the apparatus and method for operating a home network by using a building structure drawing according to the present invention, whenever types of a home network, device, system and service are added, relations to the building structure drawing are perceived and a selected resource is changed or a new efficient resource is added so that the resource selection policy is expanded.

While the invention has been shown and described with respect to the embodiments, it will be understood by those skilled in the art that various changes and modifications may be made without departing from the scope of the invention as defined in the following claims.

What is claimed is:

1. An apparatus for operating a home network, comprising:
a plurality of devices connected through the home network;
a building structure drawing DB for storing a building structure drawing regarding the inside of the building; and
a home network management system for generating service execution scheme information to provide an application service by using each device based on home network state information, determining building structure and home network configuration information based on building structure drawing information and the generated service execution scheme information, and controlling each device by determining whether to operate the application service.

2. The apparatus of claim 1, wherein the home network management system includes:
an application service logic analyzer for generating service execution scheme information of the application service, based on the home network state information collected by monitoring the state of the home network;
an application service logic reviser for perceiving a relation by combining the home network state information and the service execution scheme information transferred from the logic analyzer with the building structure drawing, and generating new service execution scheme information based on the perceived relation; and
an application service logic executor for interpreting the service execution scheme information transferred from the logic reviser and transmitting the interpreted information to the relevant devices.

3. The apparatus of claim 2, wherein the application service logic analyzer analyzes network topology information and device state information by monitoring the home network state in real-time, to generate the home network state information and service execution scheme information

4. The apparatus of claim 2, wherein the application service logic reviser combines logic by using a logic combiner, based on the home network state information and the service execution scheme information transferred from the application service analyzer, and a building structure drawing DB and a resource selection policy DB connected to the home network management system, to determine whether to revise the service execution scheme information being generated in the application service logic analyzer.

5. The apparatus of claim 4, wherein, when the service execution scheme information needs to be revised, the logic combiner re-selects or excludes a resource of a part to be revised from an operatively connected resource selection policy DB.

6. The apparatus of claim 5, wherein the resource includes functional service execution scheme information of each device and includes information of device control mode and form, control by time, and power on/off.

7. The apparatus of claim 2, wherein the application service logic executor includes:
an application service logic interpreter for performing logic interpretation of the new service execution scheme information including the selected resource information transferred from the logic reviser; and
an application service executor for transmitting an operation control command to each device, based on the information interpreted from the logic interpreter.

8. The apparatus of claim 7, wherein the operation control command includes one or more of lighting control, air-conditioner control and temperature control.

9. The apparatus of claim 1, wherein the home network state information is network topology information by monitoring the state of the home network and information of the state of the device connected to the home network.

10. The apparatus of claim 1, wherein the service execution scheme information is device control information to be performed, based on the home network state information of the application service requested by a user.

11. A method for operating a home network, comprising:
generating service execution scheme information based on home network state information and device state information when an application service of the home network is performed,
wherein a plurality of devices are connected to the home network; and
controlling each device by determining a building structure and home network configuration information based on building structure drawing information in addition to the generated service execution scheme information, and revising service execution scheme information to operate the application service.

12. The method of claim 11, further comprising:
generating service execution scheme information of the application service, based on the home network state information collected by monitoring the state of the home network;
perceiving a relation by combining the building structure drawing with the home network state information and the service execution scheme information, and generating new service execution scheme information based on the perceived relation; and
interpreting the new service execution scheme information, and transmitting the interpreted information to the relevant device.

13. The method of claim 12, wherein generating the service execution scheme information of the application service includes generating functional control scheme information of the device to perform the application service, based on the home network state information collecting monitoring information of the state of the home network and the state of the device connected to the home network.

14. The method of claim 12, wherein generating the new service execution scheme information includes combining the home network state information, the service execution scheme information and the building structure drawing information and to re-generate service execution scheme information when the service execution scheme information needs to be revised based on the relation to the building structure.

15. The method of claim 14, wherein, when the service execution scheme information needs to be revised, a resource of a part to be revised is re-selected or excluded from an operatively connected resource selection policy DB.

16. The method of claim 15, wherein the resource includes functional service execution scheme information of each device and includes information of device control mode and form, control by time, and power on/off.

17. The method of claim 12, wherein transmitting the interpreted information to the relevant device includes:
interpreting logic of selected resource information included in the new service execution scheme information; and
transmitting an operation control command to each device, based on the interpreted logic information.

18. The method of claim 11, wherein the operation control command includes at least any one of lighting control, air-conditioner control and temperature control.

19. The method of claim 11, wherein the home network state information is network topology information by monitoring the state of the home network and information of the state of the device connected to the home network.

20. The method of claim 11, wherein the service execution scheme information is device control information to be performed, based on the home network state information of the requested application service.
